(19) United States
(12) Patent Application Publication
(10) Pub. No.: US 2026/0111029 A1
(43) Pub. Date: Apr. 23, 2026

(54) SYSTEM, METHOD, AND COMPUTER PROGRAM PRODUCT FOR MONITORING AN ENVIRONMENT WITH A SWARM OF AUTONOMOUS UNDERWATER VEHICLES AND COLLABORATIVE NAVIGATION

(71) Applicant: Vatn Systems, Inc., Portsmouth, RI (US)

(72) Inventors: Steven Iannucci, South Kingstown, RI (US); Patryk Deptula, Norwood, MA (US); Richard B. Choroszucha, Oro Valley, AZ (US)

(21) Appl. No.: 19/364,794

(22) Filed: Oct. 21, 2025

Related U.S. Application Data
(60) Provisional application No. 63/710,097, filed on Oct. 22, 2024.

(51) Int. Cl. G05D 1/246; G01V 1/18; G05D 1/248; G05D 1/686; G05D 1/69; G05D 107/00; G05D 109/30; G05D 111/20; G05D 111/50

(52) U.S. Cl. CPC G05D 1/246; G01V 1/186; G05D 1/248; G05D 1/686; G05D 1/69; G05D 2107/27; G05D 2109/38; G05D 2111/20; G05D 2111/52

(57) ABSTRACT

Provided is a system, method, and product for monitoring an environment with a swarm of autonomous underwater vehicles. The system includes at least one processor configured to determine 3D data of at least a portion of an environment of the at least one AUV, determine, based on the 3D data, at least one object and a position of the at least one object in the environment, receive, from at least one other AUV of the plurality of AUVs, data representing the at least one object and the position of the at least one object, and generate, while traveling in the swarm, updated 3D data based on the 3D data and the data representing the at least one object and the position of the at least one object from the at least one other AUV.

### CROSS-REFERENCE TO RELATED APPLICATIONS

This application claims the benefit of U.S. Provisional Application No. 63/710,097 filed on Oct. 22, 2024, the entire contents of which are incorporated by reference in its entirety.

### BACKGROUND

This disclosure relates generally to autonomous underwater vehicles (AUVs) and, in non-limiting embodiments, to systems, methods, and products for monitoring an environment with a swarm of AUVs and/or collaborative navigation of AUVs.

Underwater collaboration is a longtime, unsolved problem within the marine environment. This is a result of multiple forces within the maritime space acting independently. First, many legacy AUV systems are built on out-of-date software and hardware architecture not capable of running computationally complex algorithms for mission planning and dynamic adaptation. Second, acoustic communication can be limited in both bandwidth and range. It is often capable of carrying 14 kbps at a maximum range of a few kilometers maximum. For comparison, aerial drones communicate using 4G LTE mesh networks that can communicate at 100 Mbps, allowing for multitudes of more data to be shared between agents at any time.

### SUMMARY

According to non-limiting embodiments or aspects, provided is a method comprising: determining, with at least one autonomous underwater vehicle (AUV) of a plurality of AUVs arranged in a swarm, 3D data of at least a portion of an environment of the at least one AUV; determining, with the at least one AUV based on the 3D data, at least one object and a position of the at least one object in the environment; receiving, with the at least one AUV from at least one other AUV of the plurality of AUVs, data representing the at least one object and the position of the at least one object; generating, with the at least one AUV while traveling in the swarm, updated 3D data based on the 3D data and the data representing the at least one object and the position of the at least one object from the at least one other AUV; and regenerating, with the at least one AUV while traveling in the swarm, the updated 3D data based on new 3D data determined by the at least one AUV and new data representing the at least one object and the position of the at least one object from the at least one other AUV or a different AUV.

In non-limiting embodiments or aspects, the at least one AUV is configured to communicate with at least one other vehicle via at least one communication mode. In non-limiting embodiments or aspects, the at least one communication mode comprises at least one underwater or surface communications (e.g., acoustic communication, magnetic, visual communication, or radio frequency). In non-limiting embodiments or aspects, the method further includes: controlling the at least one AUV to travel to a surface; determining, while on or within a threshold distance of the surface, a location based on a global positioning system signal; controlling the at least one AUV to travel to the swarm in a submerged location below the surface; and communicating data based on the location determined while on or within a threshold distance of the surface to one or more other AUVs of the plurality of AUVs. In non-limiting embodiments or aspects, the at least one AUV is configured to travel to the surface in response to a predicted drift satisfying a threshold. In non-limiting embodiments or aspects, the method further includes: receiving, with the at least one AUV, location data from at least one surface vessel, the position of the at least one object in the environment and/or a position of the at least one AUV is determined based on the location data received from the at least one surface vessel.

In non-limiting embodiments or aspects, the location data is represented by acoustic waves received by the at least one AUV with at least one hydrophone array. In non-limiting embodiments or aspects, the acoustic waves are received as phase-shifted time-series data, and the location data is determined based on beamforming the phase-shifted time-series data received by each hydrophone in the at least hydrophone one array. In non-limiting embodiments or aspects, the method further includes: assigning a classification from at least two classifications to each AUV of the plurality of AUVs, the at least two classifications comprising a mapping class and an interceptor class, the at least one AUV is classified in the mapping class. In non-limiting embodiments or aspects, wherein AUVs classified in the mapping class are configured to generate updated 3D data, and wherein AUVs classified in the interceptor class are not configured to generate updated 3D data. In non-limiting embodiments or aspects, the method further includes: controlling at least one second AUV of the plurality of AUVs to track and/or target at least one entity, the at least one second AUV classified in the interceptor class. In non-limiting embodiments or aspects, the method further includes: automatically assigning the classification based on an optimization algorithm and at least one AUV parameter of each AUV. In non-limiting embodiments or aspects, wherein determining the 3D data is based on a simultaneous localization and mapping algorithm that receives, as input, depth sensor data and inertial data from the at least one AUV. In non-limiting embodiments or aspects, wherein determining the at least one object based on the 3D data comprises: comparing the 3D data to an object database local to the at least one AUV, the at least one object is identified from a plurality of objects in the object database. In non-limiting embodiments or aspects, the data representing the at least one object and the position of the at least one object received from the at least one other AUV comprises a compressed data structure including an object identifier, an object location, and at least one scale factor.

In non-limiting embodiments or aspects, the data representing the at least one object and a spatial position of the at least one object is received from the at least one other AUV via at least one of a communication interface. In non-limiting embodiments or aspects, wherein generating the updated 3D data comprises: matching the at least one object with the data representing the at least one object and the position of the at least one object received from the at least one other AUV; and in response to determining that the at least one object matches the data representing the at least one object and the position of the at least one object received from the at least one other AUV, modifying the 3D data to generate the updated 3D data, the method further comprising: communicating, from the at least one AUV to the at least one other AUV, a confirmation message comprising an identification of the at least one object used to generate the updated 3D data. In non-limiting embodiments or aspects, the method further includes: storing, with the at least one AUV, the 3D data in association with the at least one object and the position of the at least one object in a database local to the at least one AUV. In non-limiting embodiments or aspects, the method further includes: determining, with at least one sensor, a sound velocity profile for water in which the plurality of AUVs are submerged; determining a propagation model based on the sound velocity profile; and communicating the data representing the at least one object and the position of the at least one object from the at least one other AUV based on the propagation model.

According to non-limiting embodiments or aspects, provided is a system comprising: at least one processor of at least one autonomous underwater vehicle (AUV) of a plurality of AUVs arranged in a swarm, the at least one processor configured to: determine 3D data of at least a portion of an environment of the at least one AUV; determine, based on the 3D data, at least one object and a position of the at least one object in the environment; receive, from at least one other AUV of the plurality of AUVs, data representing the at least one object and the position of the at least one object; generate, while traveling in the swarm, updated 3D data based on the 3D data and the data representing the at least one object and the position of the at least one object from the at least one other AUV; and regenerate the updated 3D data based on new 3D data determined by the at least one AUV and new data representing the at least one object and the position of the at least one object from the at least one other AUV or a different AUV.

In non-limiting embodiments or aspects, the at least one AUV is configured to communicate with at least one other vehicle via at least one communication mode. In nonlimiting embodiments or aspects, the at least two communication modes comprise a first mode and a second mode, the first mode comprises at least one of acoustic communication and magnetic communication, and the second mode comprises radio frequency communication. In non-limiting embodiments or aspects, the at least one processor is further configured to: control the at least one AUV to travel to a surface; determine, while on or within a threshold distance of the surface, a location based on a global positioning system signal; control the at least one AUV to travel to the swarm in a submerged location below the surface; and communicate data based on the location determined while on or within a threshold distance of the surface to one or more other AUVs of the plurality of AUVs. In non-limiting embodiments or aspects, the at least one AUV is configured to travel to the surface in response to a predicted drift satisfying a threshold. In non-limiting embodiments or aspects, the at least one processor is further configured to: receive location data from at least one surface vessel, the position of the at least one object in the environment and/or a position of the at least one AUV is determined based on the location data received from the at least one surface vessel.

In non-limiting embodiments or aspects, the location data is represented by acoustic waves received by the at least one AUV with at least one hydrophone array. In non-limiting embodiments or aspects, the acoustic waves are received as phase-shifted time-series data, and the location data is determined based on beamforming the phase-shifted time-series data received by each hydrophone in the at least hydrophone one array. In non-limiting embodiments or aspects, the at least one processor is further configured to: assign a classification from at least two classifications to each AUV of the plurality of AUVs, the at least two classifications comprising a mapping class and an interceptor class, the at least one AUV is classified in the mapping class. In non-limiting embodiments or aspects, wherein AUVs classified in the mapping class are configured to generate updated 3D data, and wherein AUVs classified in the interceptor class are not configured to generate updated 3D data. In nonlimiting embodiments or aspects, further comprising: controlling at least one second AUV of the plurality of AUVs to track and/or target at least one entity, the at least one second AUV classified in the interceptor class. In non-limiting embodiments or aspects, the at least one processor is further configured to: automatically assign the classification based on an optimization algorithm and at least one AUV parameter of each AUV. In non-limiting embodiments or aspects, wherein determining the 3D data is based on a simultaneous localization and mapping algorithm that receives, as input, depth sensor data and inertial data from the at least one AUV. In non-limiting embodiments or aspects, wherein determining the at least one object based on the 3D data comprises: comparing the 3D data to an object database local to the at least one AUV, the at least one object is identified from a plurality of objects in the object database.

In non-limiting embodiments or aspects, the data representing the at least one object and the position of the at least one object received from the at least one other AUV comprises a compressed data structure including an object identifier, an object location, and at least one scale factor. In non-limiting embodiments or aspects, the data representing the at least one object and a spatial position of the at least one object is received from the at least one other AUV via at least one of an acoustic communication interface and a magnetic communication interface. In non-limiting embodiments or aspects, wherein generating the updated 3D data comprises: matching the at least one object with the data representing the at least one object and the position of the at least one object received from the at least one other AUV; and in response to determining that the at least one object matches the data representing the at least one object and the position of the at least one object received from the at least one other AUV, modifying the 3D data to generate the updated 3D data, the method further comprising: communicating, from the at least one AUV to the at least one other AUV, a confirmation message comprising an identification of the at least one object used to generate the updated 3D data. In non-limiting embodiments or aspects, the at least one processor is further configured to: store the 3D data in association with the at least one object and the position of the at least one object in a database local to the at least one AUV. In non-limiting embodiments or aspects, the at least one processor is further configured to: determine, with at least one sensor, a sound velocity profile for water in which the plurality of AUVs are submerged; determine a propagation model based on the sound velocity profile; and communicate the data representing the at least one object and the position of the at least one object from the at least one other AUV based on the propagation model.

According to non-limiting embodiments or aspects, provided is a computer program product comprising at least one non-transitory computer-readable medium including program instructions that, when executed by at least one processor, cause the at least one processor to perform the steps of any of the above embodiments.

According to non-limiting embodiments or aspects, provided is a system comprising a plurality of autonomous underwater vehicles (AUV), each AUV comprising: at least one inertial sensor; at least one depth sensor; at least one communication interface configured to communicate signals via at least two communication modes, wherein at least one communication mode is configured to communicate signals under water; at least one data storage device comprising an object database; and at least one computing device in communication with the at least one inertial sensor, the at least one depth sensor, the at least one communication interface, and the at least one data storage device, the at least one computing device configured to: determine, based on the at least one depth sensor, 3D data of at least a portion of an environment; determine, based on the 3D data, at least one object and a location of the at least one object in the environment; receive, via the at least one communication interface from at least one other AUV of the plurality of AUVs, data representing the at least one object and the location of the at least one object; and generate, while the AUV is traveling, updated 3D data based on the 3D data and the data representing the at least one object and a position of the at least one object from the at least one other AUV.

In non-limiting embodiments or aspects, the system includes: a second plurality of AUVs, each AUV of the second plurality of AUVs comprising: at least one inertial sensor; at least one communication interface configured to receive signals from at least one AUV of the plurality of AUVs; and at least one computing device in communication with the at least one inertial sensor and the at least one communication interface. In non-limiting embodiments or aspects, the system includes: at least one surface vessel comprising a global positioning system, at least one communication interface, and at least one computing device configured to communicate location data from the global positioning system to at least one AUV of the plurality of AUVs.

According to non-limiting embodiments or aspects, provided is a method comprising: classifying at least one autonomous underwater vehicle (AUV) of a plurality of AUVs as a primary AUV, the primary AUV comprising a transceiver and an inertial navigation system such as a fiber-optic gyroscope; classifying remaining AUVs of the plurality of AUVs as secondary AUVs, each secondary AUV comprising an inertial navigation system such as a micro-electromechanical inertial sensor; and controlling the plurality of AUVs by configuring the primary AUV for an objective, the primary AUV configured to control the remaining AUVs using the transceiver based on the objective and a position of the primary AUV.

According to non-limiting embodiments or aspects, provided is a system comprising: at least one first autonomous underwater vehicle (AUV) comprising a processor, a transceiver, and an inertial navigation system such as a fiber-optic gyroscope; and a plurality of second AUVs comprising at least a processor, a receiver, and an inertial navigation system such as a micro-electromechanical inertial sensor, the at least one first AUV is configured to control the plurality of second AUVs.

Other preferred and non-limiting embodiments or aspects of the present solution will be set forth in the following numbered clauses:
Clause 1: A method comprising: determining, with at least one autonomous underwater vehicle (AUV) of a plurality of AUVs arranged in a swarm, 3D data of at least a portion of an environment of the at least one AUV; determining, with the at least one AUV based on the 3D data, at least one object and a position of the at least one object in the environment; receiving, with the at least one AUV from at least one other AUV of the plurality of AUVs, data representing the at least one object and the position of the at least one object; generating, with the at least one AUV while traveling in the swarm, updated 3D data based on the 3D data and the data representing the at least one object and the position of the at least one object from the at least one other AUV; and regenerating, with the at least one AUV while traveling in the swarm, the updated 3D data based on new 3D data determined by the at least one AUV and new data representing the at least one object and the position of the at least one object from the at least one other AUV or a different AUV.
Clause 2: The method of clause 1, wherein the at least one AUV is configured to communicate with at least one other vehicle via at least two communication modes.
Clause 3: The method of clause 1 or 2, wherein the at least two communication modes comprise a first mode and a second mode, wherein the first mode comprises at least one of acoustic communication and magnetic communication, and wherein the second mode comprises radio frequency communication.
Clause 4: The method of any of clauses 1-3, further comprising: controlling the at least one AUV to travel to a surface; determining, while on or within a threshold distance of the surface, a location based on a global positioning system signal; controlling the at least one AUV to travel to the swarm in a submerged location below the surface; and communicating data based on the location determined while on or within a threshold distance of the surface to one or more other AUVs of the plurality of AUVs.
Clause 5: The method of any of clauses 1-4, wherein the at least one AUV is configured to travel to the surface in response to a predicted drift satisfying a threshold.
Clause 6: The method of any of clauses 1-5, further comprising: receiving, with the at least one AUV, location data from at least one surface vessel, wherein the position of the at least one object in the environment and/or a position of the at least one AUV is determined based on the location data received from the at least one surface vessel.
Clause 7: The method of any of clauses 1-6, wherein the location data is represented by acoustic waves received by the at least one AUV with at least one hydrophone array.
Clause 8: The method of any of clauses 1-7, wherein the acoustic waves are received as phase-shifted time-series data, and wherein the location data is determined based on beamforming the phase-shifted time-series data received by each hydrophone in the at least hydrophone one array.
Clause 9: The method of any of clauses 1-8, further comprising: assigning a classification from at least two classifications to each AUV of the plurality of AUVs, the at least two classifications comprising a mapping class and an interceptor class, wherein the at least one AUV is classified in the mapping class.
Clause 10: The method of any of clauses 1-9, wherein AUVs classified in the mapping class are configured to generate updated 3D data, and wherein AUVs classified in the interceptor class are not configured to generate updated 3D data.
Clause 11: The method of any of clauses 1-10, further comprising: controlling at least one second AUV of the plurality of AUVs to track and/or target at least one entity, the at least one second AUV classified in the interceptor class.
Clause 12: The method of any of clauses 1-11, further comprising: automatically assigning the classification based on an optimization algorithm and at least one AUV parameter of each AUV.
Clause 13: The method of any of clauses 1-12, wherein determining the 3D data is based on a simultaneous localization and mapping algorithm that receives, as input, depth sensor data and inertial data from the at least one AUV.
Clause 14: The method of any of clauses 1-13, wherein determining the at least one object based on the 3D data comprises: comparing the 3D data to an object database local to the at least one AUV, wherein the at least one object is identified from a plurality of objects in the object database.
Clause 15: The method of any of clauses 1-14, wherein the data representing the at least one object and the position of the at least one object received from the at least one other AUV comprises a compressed data structure including an object identifier, an object location, and at least one scale factor.
Clause 16: The method of any of clauses 1-15, wherein the data representing the at least one object and a spatial position of the at least one object is received from the at least one other AUV via at least one of an acoustic communication interface and a magnetic communication interface.
Clause 17: The method of any of clauses 1-16, wherein generating the updated 3D data comprises: matching the at least one object with the data representing the at least one object and the position of the at least one object received from the at least one other AUV; and in response to determining that the at least one object matches the data representing the at least one object and the position of the at least one object received from the at least one other AUV, modifying the 3D data to generate the updated 3D data, the method further comprising: communicating, from the at least one AUV to the at least one other AUV, a confirmation message comprising an identification of the at least one object used to generate the updated 3D data.
Clause 18: The method of any of clauses 1-17, further comprising: storing, with the at least one AUV, the 3D data in association with the at least one object and the position of the at least one object in a database local to the at least one AUV.
Clause 19: The method of any of clauses 1-18, further comprising: determining, with at least one sensor, a sound velocity profile for water in which the plurality of AUVs are submerged; determining a propagation model based on the sound velocity profile; and communicating the data representing the at least one object and the position of the at least one object from the at least one other AUV based on the propagation model.
Clause 20: A system comprising: at least one processor of at least one autonomous underwater vehicle (AUV) of a plurality of AUVs arranged in a swarm, the at least one processor configured to: determine 3D data of at least a portion of an environment of the at least one AUV; determine, based on the 3D data, at least one object and a position of the at least one object in the environment; receive, from at least one other AUV of the plurality of AUVs, data representing the at least one object and the position of the at least one object; generate, while traveling in the swarm, updated 3D data based on the 3D data and the data representing the at least one object and the position of the at least one object from the at least one other AUV; and regenerate the updated 3D data based on new 3D data determined by the at least one AUV and new data representing the at least one object and the position of the at least one object from the at least one other AUV or a different AUV.
Clause 21: The system of clause 20, wherein the at least one AUV is configured to communicate with at least one other vehicle via at least two communication modes.
Clause 22: The system of clause 20 or 21, wherein the at least two communication modes comprise a first mode and a second mode, wherein the first mode comprises at least one of acoustic communication and magnetic communication, and wherein the second mode comprises radio frequency communication.
Clause 23: The system of any of clauses 20-22, wherein the at least one processor is further configured to: control the at least one AUV to travel to a surface; determine, while on or within a threshold distance of the surface, a location based on a global positioning system signal; control the at least one AUV to travel to the swarm in a submerged location below the surface; and communicate data based on the location determined while on or within a threshold distance of the surface to one or more other AUVs of the plurality of AUVs.
Clause 24: The system of any of clauses 20-23, wherein the at least one AUV is configured to travel to the surface in response to a predicted drift satisfying a threshold.
Clause 25: The system of any of clauses 20-24, wherein the at least one processor is further configured to: receive location data from at least one surface vessel, wherein the position of the at least one object in the environment and/or a position of the at least one AUV is determined based on the location data received from the at least one surface vessel.
Clause 26: The system of any of clauses 20-25, wherein the location data is represented by acoustic waves received by the at least one AUV with at least one hydrophone array.
Clause 27: The system of any of clauses 20-26, wherein the acoustic waves are received as phase-shifted time-series data, and wherein the location data is determined based on beamforming the phase-shifted time-series data received by each hydrophone in the at least hydrophone one array.
Clause 28: The system of any of clauses 20-27, wherein the at least one processor is further configured to: assign a classification from at least two classifications to each AUV of the plurality of AUVs, the at least two classifications comprising a mapping class and an interceptor class, wherein the at least one AUV is classified in the mapping class.
Clause 29: The system of any of clauses 20-28, wherein AUVs classified in the mapping class are configured to generate updated 3D data, and wherein AUVs classified in the interceptor class are not configured to generate updated 3D data.
Clause 30: The system of any of clauses 20-29, further comprising: controlling at least one second AUV of the plurality of AUVs to track and/or target at least one entity, the at least one second AUV classified in the interceptor class.
Clause 31: The system of any of clauses 20-30, wherein the at least one processor is further configured to: automatically assign the classification based on an optimization algorithm and at least one AUV parameter of each AUV.
Clause 32: The system of any of clauses 20-31, wherein determining the 3D data is based on a simultaneous localization and mapping algorithm that receives, as input, depth sensor data and inertial data from the at least one AUV.
Clause 33: The system of any of clauses 20-32, wherein determining the at least one object based on the 3D data comprises: comparing the 3D data to an object database local to the at least one AUV, wherein the at least one object is identified from a plurality of objects in the object database.
Clause 34: The system of any of clauses 20-33, wherein the data representing the at least one object and the position of the at least one object received from the at least one other AUV comprises a compressed data structure including an object identifier, an object location, and at least one scale factor.
Clause 35: The system of any of clauses 20-34, wherein the data representing the at least one object and a spatial position of the at least one object is received from the at least one other AUV via at least one of an acoustic communication interface and a magnetic communication interface.
Clause 36: The system of any of clauses 20-35, wherein generating the updated 3D data comprises: matching the at least one object with the data representing the at least one object and the position of the at least one object received from the at least one other AUV; and in response to determining that the at least one object matches the data representing the at least one object and the position of the at least one object received from the at least one other AUV, modifying the 3D data to generate the updated 3D data, the at least one processor further configured to: communicating, from the at least one AUV to the at least one other AUV, a confirmation message comprising an identification of the at least one object used to generate the updated 3D data.
Clause 37: The system of any of clauses 20-36, wherein the at least one processor is further configured to: store the 3D data in association with the at least one object and the position of the at least one object in a database local to the at least one AUV.
Clause 38: The system of any of clauses 20-37, wherein the at least one processor is further configured to: determine, with at least one sensor, a sound velocity profile for water in which the plurality of AUVs are submerged; determine a propagation model based on the sound velocity profile; and communicate the data representing the at least one object and the position of the at least one object from the at least one other AUV based on the propagation model.
Clause 39: A computer program product comprising at least one non-transitory computer-readable medium including program instructions that, when executed by at least one processor, cause the at least one processor to perform the steps of any of clauses 1-19.
Clause 40: A system comprising a plurality of autonomous underwater vehicles (AUV), each AUV comprising: at least one inertial sensor; at least one depth sensor; at least one communication interface configured to communicate signals via at least two communication modes, wherein at least one communication mode is configured to communicate signals under water; at least one data storage device comprising an object database; and at least one computing device in communication with the at least one inertial sensor, the at least one depth sensor, the at least one communication interface, and the at least one data storage device, the at least one computing device configured to: determine, based on the at least one depth sensor, 3D data of at least a portion of an environment; determine, based on the 3D data, at least one object and a location of the at least one object in the environment; receive, via the at least one communication interface from at least one other AUV of the plurality of AUVs, data representing the at least one object and the location of the at least one object; and generate, while the AUV is traveling, updated 3D data based on the 3D data and the data representing the at least one object and a position of the at least one object from the at least one other AUV.
Clause 41: The system of clause 40, further comprising: a second plurality of AUVs, each AUV of the second plurality of AUVs comprising: at least one inertial sensor; at least one communication interface configured to receive signals from at least one AUV of the plurality of AUVs; and at least one computing device in communication with the at least one inertial sensor and the at least one communication interface.
Clause 42: The system of clause 40 or 41, further comprising: at least one surface vessel comprising a global positioning system, at least one communication interface, and at least one computing device configured to communicate location data from the global positioning system to at least one AUV of the plurality of AUVs.
Clause 43: A method comprising: classifying at least one autonomous underwater vehicle (AUV) of a plurality of AUVs as a primary AUV, the primary AUV comprising a transceiver and an inertial navigation system such as a fiber-optic gyroscope; classifying remaining AUVs of the plurality of AUVs as secondary AUVs, each secondary AUV comprising an inertial navigation system such as a micro-electromechanical inertial sensor; and controlling the plurality of AUVs by configuring the primary AUV for an objective, the primary AUV configured to control the remaining AUVs using the transceiver based on the objective and a position of the primary AUV.
Clause 44: A system comprising: at least one first autonomous underwater vehicle (AUV) comprising a processor, a transceiver, and an inertial navigation system including a fiber-optic gyroscope; and a plurality of second AUVs comprising at least a processor, a receiver, and an inertial navigation system including a micro-electromechanical inertial sensor, wherein the at least one first AUV is configured to control the plurality of second AUVs.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### DESCRIPTION OF DRAWINGS

Additional advantages and details are explained in greater detail below with reference to the non-limiting, exemplary embodiments that are illustrated in the accompanying figures shown in the separate attachment, in which:

FIG. 1 is a schematic diagram of a system for monitoring an environment with a swarm of autonomous underwater vehicles according to non-limiting embodiments or aspects;

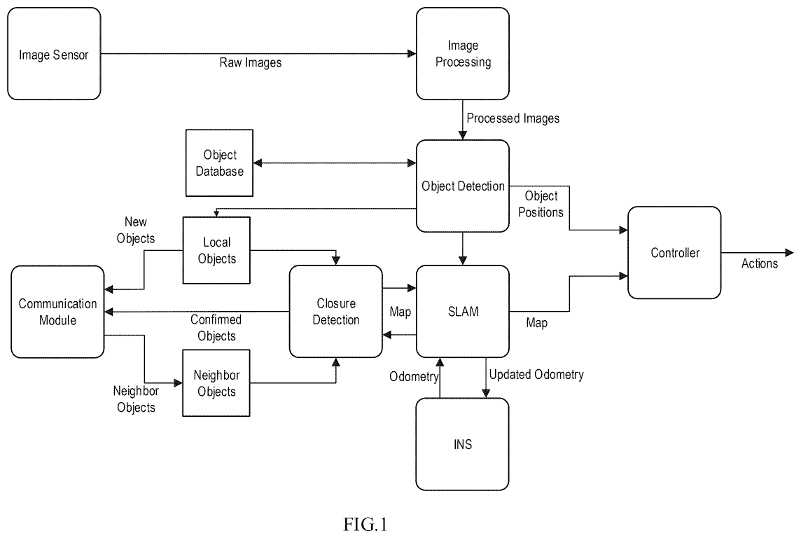

FIG. 2 is a diagram showing communication between two autonomous underwater vehicles according to non-limiting embodiments or aspects;

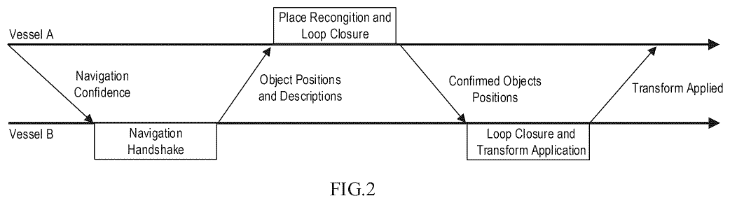

FIG. 3 is an example chart of 3D beamforming from an array of hydrophones according to non-limiting embodiments or aspects;

FIG. 4 is a diagram showing a transmission loss model according to non-limiting embodiments or aspects;

FIG. 5 shows a chart of acoustic transmission dependency on bathymetry and sound velocity profiles according to non-limiting embodiments;

FIG. 6. illustrates example components of a computing device used in connection with non-limiting embodiments; and

FIG. 7 illustrates a schematic diagram of a system for collaborative navigation of a swarm of autonomous underwater vehicles according to non-limiting embodiments or aspects.

### DETAILED DESCRIPTION

It is to be understood that the embodiments may assume various alternative variations and step sequences, except where expressly specified to the contrary. It is also to be understood that the specific devices and processes described in the following specification are simply exemplary embodiments or aspects of the disclosure. Hence, specific dimensions and other physical characteristics related to the embodiments or aspects disclosed herein are not to be considered as limiting. No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “computing device” may refer to one or more electronic devices configured to process data. A computing device may include, for example, a processor such as a Central Processing Unit (CPU), a Graphics Processing Unit (GPU), a microprocessor, a controller, and/or any other computational device capable of executing logic. A “computer readable medium” may refer to one or more memory devices or other non-transitory storage mechanisms capable of storing compiled or non-compiled program instructions for execution by one or more computing devices. Reference to “a processor” or “a computing device” as used herein, may refer to a previously-recited computing device and/or processor that is recited as performing a previous step or function, a different server and/or processor, and/or a combination of computing devices and/or processors. For example, as used in the specification and the claims, a first computing device and/or a first processor that is recited as performing a first step or function may refer to the same or different computing device and/or a processor recited as performing a second step or function.

Non-limiting embodiments provide for a framework and system capabilities to enable dynamic collaborative underwater agents. In non-limiting embodiments, each agent (e.g., vehicle, such as an autonomous underwater vehicle) is assigned to be either an interceptor or a monitoring/mapping class (e.g., clique) of agent. Agents of each class will form a distributed pod, where information sharing between agents depends on the mission (e.g., can be broadcast to each agent or subset of agents, and the communication graphs can be directed or undirected). This system may be designed for multiple dynamic missions. Mission capabilities range from survey grade mapping and port security, to long-range tracking of adversarial agents and interception. The modular framework of tools described herein provides flexibility to the operator and collaborative swarm during runtime.

Non-limiting embodiments may include a system of connected heterogeneous autonomous surface vehicles (ASVs) and autonomous underwater vehicles (AUVs) with a modular sensor suite, communication hardware, and autonomy package that with or without human input can accomplish tasks as teams or individually to reach a goal. It leverages a modular communication subsystem comprised of mixed mode surface and underwater communications to achieve short-and long-range communications with varying bandwidths for multiple purposes in contested and denied environments (e.g., environments in which a global positioning system signal is blocked, where radio frequency may not be effective, where visual detection may not be effective, etc.). The system may incorporate adaptive learning to define the algorithms to autonomously control the swarm of vessels.

Non-limiting embodiments provide for multi-tiered (e.g., two or more classes) architecture for a swarm of AUVs and/or ASVs (e.g., agents) organized into pods. First, a mapping/monitoring class (e.g., clique) of vessels may be responsible for long-range tracking, mapping, and any other sensing tasks. Second, an interceptor class/clique of vessels may be responsible for protection, close-range tracking, and targeting of adversarial agents. Each class/clique may act as distributed swarms themselves, sharing information with neighbors of the same class/clique and/or team of vessels. Collectively, the swarm may allocate tasks based on available sensor, communication, and autonomy suite and may dynamically reassign tasks to accomplish a local or global goal. A vessel can have a dynamic class, where it begins the mission as a mapping agent but is later required to intercept due to loss of vessels within the intercept swarm. A swarm manager which includes a task allocator will be able to determine which class along with which behavior a vehicle is in. The swarm manager may be a distributed or centralized software function executed by a remote computing device, a local computing device to one of the AUVs, and/or the like.

In non-limiting embodiments, one or more of following sensors may be used for surface and underwater usage: Conductivity, Temperature, and Depth (CTD), Sonar (side scan, 3D, SAS, multi-beam, etc.), Doppler velocity log (DVL), LIDAR, Hydrophone, Electrooptical/Infrared/UV (multi-and hyperspectral cameras), GPS, Magnetometer, Barometer, and/or inertial measurement unit (IMU). It will be appreciated that other types of sensors may be used in non-limiting embodiments.

In non-limiting embodiments, encrypted or unencrypted mixed-mode communications may be used to communicate between vessels/agents. For example, acoustic communications (ACOMMs) and magnetic communications may be used underwater, while at the surface larger amounts of data may be transmitted between agents using radio frequency communications (WiFi®, LORA, and/or the like) or optical communications.

In non-limiting embodiments, one or more vessels of a swarm may be assigned one or more of the following tasks/behaviors: search/rescue, tracking, interception of agents, mapping, monitoring/Command, Control, Communications, Computers, Intelligence, Surveillance, and Reconnaissance, recover, camouflage, and/or the like.

Prior to beginning a behavior, each vessel in the swarm may be assigned a classification at initialization. The assigned class may be primarily based on the sensor(s) and/or tools on each agent. This class initialization will either be assigned by an operator or automatically by an optimization approach which determines the best agents for each class with an optimization algorithm. The assignment may be re-evaluated online for retasking in the event of agent attrition or a change in goals, as examples. For instance, multi-objective optimization in the task allocation module may be leveraged while considering factors such as, for example, battery, sensor health, vehicle capabilities, and/or mission priorities. Other agent parameters, environmental parameters, and/or mission parameters may be used in non-limiting embodiments. This approach ensures that task assignments are balanced and optimal based on the current operational context. For example, an agent with a hydrophone array or expensive side scan sonar may be responsible for tracking or mapping as its primary task. An agent equipped with at least a forward-looking sonar and side scan sonar may have active mapping enabled.

Swarming Network Configurations: In non-limiting embodiments, the network topology for the swarm may take any form such that mathematical guarantees may be achieved for a goal, e.g., network connectedness is achieved over a time window, or a directed graph is used for a leader/follower configuration.

Software and Example Concept of Operation (CONOP): One example CONOP is an area denial and mapping/identification mission. The agents may be separated into two different classes: a mapping class and an interceptor class. The mapping class is composed of high value agents while the interceptor class is composed of cheaper, attritable assets. The monitoring/mapping class agents map and perform long-range target identification and tracking, while the interceptor class agents track and may be designed for protection, close range tracking, and targeting of adversarial agents.

At the onset of the operation, a software package may be loaded onto each agent, given it has the onboard processing power needed, or as a payload embedded into a high-performance processor. For example, an embedded Linux (or other like operating system) computer with a dedicated graphics processor may be used for at least some software capabilities within the package. The software package may include several modules which allows the agent to have a greater understanding of its environment and position within the environment. Safety guidelines may be established at the beginning of missions, limiting each agent to exclusively fulfill tasks assigned by the user or autonomous allocation in some nonlimiting embodiments.

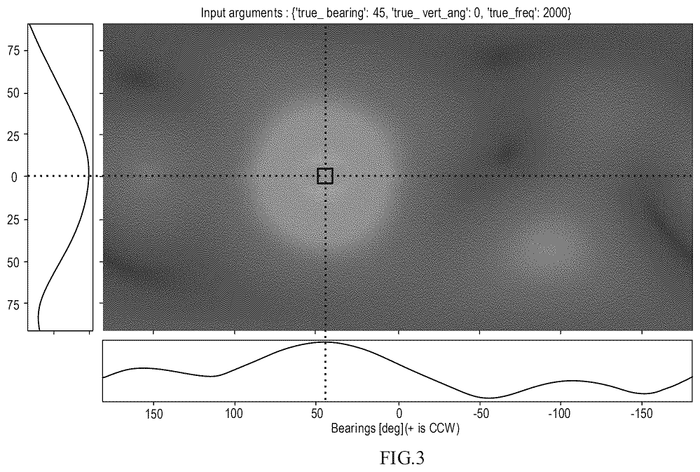

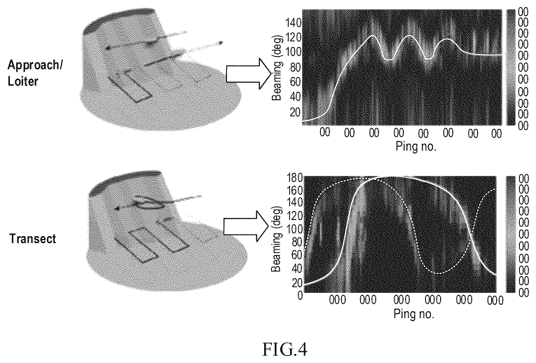

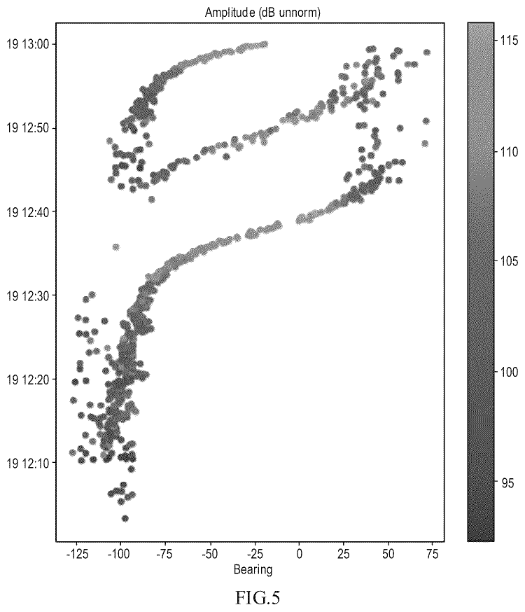

To ensure communication between all agents, at the beginning of the mission one or more of the mapping class agents may use a Conductivity, Temperature, and Depth (CTD) sensor, or other suitable sensor and/or sensor suite, to probe the water column and estimate the sound velocity profile (SVP). The SVP data from the CTD sensor, along with a bathymetric map, may be used to estimate propagation amplitude and coherence by running, for example, a ray trace mode via BELLHOP, a part of an acoustics toolbox, or other like software-based methods. This software may use sound speed information to estimate acoustic arrivals, transmission loss, and/or ray paths for the environment. The propagation model may be used to predict the likelihood of effective acoustic communication based on acoustic modem parameters, range between transmission/receiver agents, and transmit/receive depths. This data can be shared between agents as a table or image array. In use, when two agents are attempting to communicate, if the distance between is relatively known, this likelihood map may be used to adapt agent depth and behavior to maximize the chances of effective acoustic communication. FIG. 5 depicts how acoustic transmission is dependent on both bathymetry and sound velocity profiles. This image indicates how profile (yellow dots) can change the way sound propagates in the ocean. FIG. 4 displays an example bellhop transmission loss model. FIG. 3 highlights the importance of using SVP data to adjust autonomy; the best depth selection at a range of, e.g., 10 km, varies significantly with whether a shallow duct is present (top) versus not present (bottom).

Each agent within the mapping class of agents may perform single-agent simultaneous localization and mapping (SLAM) independently when neighbors are not close enough for communication. The agents may also perform single-agent SLAM within communication range, concurrently with distributed SLAM. Each agent may ingest available sensor data (sonar, LIDAR, stereo, optical, magnetic, IMU, and/or the like) as the main input into the SLAM algorithm. When agents are within communication distance, the distributed SLAM protocol may automatically take effect. The swarm may use a distributed SLAM algorithm that, when in communication with close neighbors, increases the accuracy of each agent's 3D data (e.g., map) and corresponding navigation solution within the environment map or a volume being explored. The data may be 3D data, such as point cloud data, representing depth information for at least a portion of the environment. If other agents'positions are unknown, the agent may estimate the other agents' position along with an error metric using techniques such as Time, Phase, or Frequency Difference of Arrival in order to get within communication radius and perform map fusion/mosaicking with shared information.

In one non-limiting example of an agent completing single-agent SLAM, it may be ingesting forward-looking sonar images, or other image data, along with the vehicle's odometry (e.g., determined from one or more inertial measurement units (IMUs) or the like). The sonar images may be converted into a 3D point cloud representation using a Rao-Blackwellised particle filtering (RBPF)-SLAM implementation or any other method known to those skilled in the art. RBPF-SLAM may be used due to its robust functionality on large point cloud datasets and success onboard underwater agents with a forward looking sonar, but it will be appreciated that other methods to generate point cloud data may be used.

An additional module and/or another function of the same module that performs the SLAM may ingest the generated point cloud data and attempt to classify the objects represented by the point cloud data against a predetermined semantic database, segment the point cloud data based on the object(s), and localize the object(s) within the created map. This database may hold information about basic objects found under water (e.g., such as mines, mooring anchors, and/or the like) and their 3D point cloud representations. A sweep algorithm performed on the point cloud data may generate a local database of objects, their global position, and a scaling factor that the agent has detected. The incoming point clouds generated from the sensor images may be segmented and classified automatically using, for example, the PointNet++ algorithm or any other deep learning segmentation and classification algorithm. To utilize deep learning techniques, a model may be trained to recognize the object(s) within the precompiled database of objects. Model reduction may be leveraged to increase online inference time. A neural network solution is more computationally efficient and accurate than comparative unsupervised learning methods of point cloud segmentation and classification, although it will be appreciated that any segmentation and classification methods may be used in non-limiting embodiments.

An update swarm-based SLAM called DOOR-SLAM has been used to increase the accuracy of a UAV's localization by sending encoded information. The framework passed Vector of Locally Aggregated Descriptors (VLAD), which is a tool used in feature mapping for optical based cameras. Implementation of such an algorithm would not be feasible under water because the VLAD messages hold feature images that require too much bandwidth for acoustic communication. Instead, non-limiting embodiments use unique segmentation and feature extraction algorithms and techniques to distill key components of a map (e.g., point cloud data) to a set of objects that can be presented in a small amount of data suitable for low-bandwidth (e.g., acoustic, magnetic, and/or the like) communication.

In instances when larger amounts of data need to be transmitted between vessels, the vessels may be configured to surface in order to utilize higher rate communication such as RF, WiFi®, satellite, or the like.

In non-limiting embodiments, when in communication with a neighboring agent (e.g., an AUV within communication range), an AUV (e.g., an initial agent or any other AUV in the swarm) may transmit information about the objects detected (e.g., object identifiers), their locations, and scale factors as a compressed string or other reduced-sized data structure that can be passed over low-bandwidth communication interfaces such as acoustic links. The neighbor AUV may ingest the object information and match it against its own database of objects identified. If the distance between objects or their distance is within a threshold, the neighboring agent can use this information to close the loop within its local point cloud map. Closing the loop is beneficial for two reasons: first, dead-reckoning is never perfectly accurate, and second, for determining if a location has been visited before. Inter-agent loop closure helps to ensure that each agent is working from central global references, which is important for coordinated maneuvers in GPS-denied areas. If communication is occurring between agents, the swarm can close loops even if a single agent does not revisit the same location.

The neighboring agent(s) may confirm the objects used to close the loop on its system and send back the objects used to do so (e.g., such as a confirmation message identifying the object(s) used to complete its point cloud map). The initial agent may accept the information as true and then convert the incoming object representations as a point-cloud. Next, the AUV may use a random sample consensus (RANSAC) based algorithm to merge (e.g., fuse and/or mosaic) the two misaligned maps with each other, simultaneously increasing the accuracy of both its map and pose estimation. It will be appreciated that other algorithms and/or techniques may be used to combine two point cloud maps. The agent with the most accurate positional data at the time of collection may be given priority in registration. This prevents the transmission of erroneous data from an agent that has experienced inertial drift to one that has recently obtained a GPS fix or the like and is more recently certain of its accurate global position. By sending only object specific information, the maps across the swarm may be updated over time to include information from agents on the other side of the environment. The AUVs may also communicate indirectly, using the other AUVs as nodes in a low-bandwidth mesh network to communicate object information.

In certain missions, to reduce battery consumption from continuous communication, event-driven communication may be implemented, where data is shared only when significant changes occur, such as detection of a new object (e.g., possibly adverse) or a major shift in map accuracy (e.g., a shift satisfying a threshold). This approach helps minimize acoustic communication use and conserves bandwidth for higher-priority (e.g., critical) information.

In non-limiting embodiments, to provide smooth mapping operations area denial (e.g., prevention and/or blockage of an entity) may be implemented. In non-limiting embodiments, in addition to mapping, the agents classified as mappers may track surface vessels using an on-board hydrophone array with passive acoustic detection, classification, localization, and tracking processing chains. A hydrophone array on the AUV collects phase-shifted time series data; that data may be digitized in an analog-to-digital conversion system and streamed to a computing device on the AUV. That time-series data may then be beamformed with the spatial sampling data of the multiple hydrophones in the array providing information on the bearing and elevation of the target sound source. A vessel type may be classified by analyzing time-frequency characteristics. A given target is then tracked in space using a particle filter, Kalman filter, and/or a nonlinear state estimator with multiple bearing/elevation estimates (e.g., particle swarm optimization, a Gaussian mixture model, and/or other like methods) and own-ship navigation as inputs; vessel behavior and intent prediction may also be classified directly from bearing information. In addition, Doppler shift and amplitude changes may be used to provide estimates of velocity and range. In coastal waters, the acoustic energy from a surface vessel is channeled in the waveguide, with practical ranges of detection of between 1 km and 30 km depending on water depth, sound velocity profile, and received depth.

In non-limiting embodiments, long-range tracking may be performed with an embedded hydrophone. These technologies allow a vessel to estimate the position based on acoustic signature from several kilometers away.

An agent with long-range tracking sensors onboard may also be tasked with coordinating and commanding the interceptor cliques of agents toward the target.

Software may control the interceptor class of agents. These agents may have forward looking sensors onboard to help guide the agent towards a target during terminal homing. This class may primarily take instructions from the mapping class of agents. During a typical mission, an interceptor agent may listen to communications between the mapping class agents to gain an understanding of their positions. In addition, adaptive swarm behavior mechanisms that change based on perceived threat levels may be implemented. For instance, if a significant threat is detected, or there is no target to intercept, the swarm may automatically adopt more defensive formations and/or prioritize the protection of critical assets within the mapping class. The interceptor agents may form a strategic formation to enable instant autonomous engagement with a target. These vessels may communicate a ranking between them before creating the formation.

The network topology, communications, and sensor suite tie into the swarming capabilities. In non-limiting embodiments, the formation for these agents to perform tasks may be in the form of a train or chain. Using the forward-looking sensor, agents may be tasked with following the vessel/agent directly in front of them. Autonomous controls, such as proportional-integral-derivative (PID), nonlinear, or control barrier-based controllers may be used to keep the agent a set distance behind the leader. If a leading vehicle is too far to be sensed, an estimator can be leveraged to allow the following agent to remain in this simple formation. This is advantageous for keeping acoustic communications and/or other low-bandwidth communications active between the swarm as the vessels in the train act as nodes in an ad hoc acoustic network. The leader of the train may be the first to be deployed into action. For more complex formations, predictive modeling algorithms in the interceptor clique may be used to anticipate the movements of potential targets based on their behaviors. These predictions can guide interceptors toward strategic positions for optimal engagement, as an example.

In non-limiting embodiments, if an unmanned surface vehicle (USV) agent is included in a swarm, its technologies can be leveraged to increase navigational accuracy for subsea agents. Using onboard Ultra Short Baseline (USBL) communication, the position of each agent in the swarm may be calculated and used to aid the underwater inertial navigation system, limiting the drift of the position output that can be found in all dead-reckoning situations. Limiting the amount of time an AUV agent is on the surface to reset the inertial navigation system (INS) with a GPS position increases operational efficiency and limits exposure. USV agents in the mapping class may deploy their camera and/or perception systems to perform target recognition from a distance, offering another method for tracking silent or unidentifiable vessels. Machine learning-based methods for target recognition may be developed on numerous images of vessels.

In non-limiting embodiments, when the mission has concluded and all tasks have been performed or the mission timeout has been reached, the agents may enter recovery mode. Each agent may be responsible for navigating back to the rally point for extraction. A global path to the rally point may be generated based on the current position of the agent. Local object avoidance may be active to guide the vessel away from possible obstacles, where the global path following can be resumed.

With the agents communicating data and/or collecting data following a mission, continual learning, utilizing either edge computing or offline computing, may be leveraged from missions to develop adapted behaviors for AUVs. This allows the AUV swarm to modify its behaviors over time, improving its efficiency and response to various scenarios based on previous successes and failures.

### Collaborative Navigation

In non-limiting embodiments, the agents may be configured to collaboratively navigate an environment. Leveraging collaborative autonomous underwater operations and long-range navigation will allow entities to, for example, rapidly search large areas of the seafloor, even when the surface and air environments are defended by advanced enemy anti-access and/or area denial capabilities. Collaborative AUV pods (e.g., swarms or groups of agents working in collaboration) may ensure that submarine and surface assets will be able to transit areas defended by bottom mines, seafloor emplaced detection systems and other maritime infrastructure by conducting pathfinding operations, locating and neutralizing threats, and/or defending cleared routes from reseeding by providing a loitering targeting capability. Such agents may also be configured to engage in swarming attacks.

In non-limiting embodiments, collaborative autonomous behaviors, heterogenous swarming capability, and an inertial navigation system are provided for collaborative navigation of a pod of agents. In non-limiting embodiments, the system provides for the capability to conduct long-range, clandestine subsea operations with collaborative attritable autonomous systems at scale by organizing agents in hierarchical heterogeneous groups (e.g., pods). Collaborative autonomy, as provided by non-limiting embodiments described herein, addresses the imbalance between communication and sensor limitations that compete with the vastness of the maritime environment. Non-limiting embodiments also solve manpower challenges by replacing current systems, which require multiple operators for a single vehicle, with collaborative agents that provide single operators with large numbers of synchronized effects (e.g., such that it may be a force multiplier).

Underwater navigation is an important capability for effective subsea autonomy. Currently available solutions are based on two core movement detection technologies: (1) an inertial measurement technology that provides a high level of performance like a Fiber Optic Gyroscope (FOG) or Ring Laser Gyro (RLG), but their high cost can make them unsuitable for high volume or attritable systems; and (2) an inertial measurement technology that provides a low level of performance like a Micro-Electromechanical (MEMs) sensors that are inexpensive, but are not sufficiently accurate to support long range subsurface AUV operations.

In non-limiting embodiments, at least one agent (e.g., AUV) will be classified as an “Alpha” agent and may be provided with a FOG-based or other high level of performance inertial navigation system and/or other like higher-cost navigation units. The “Alpha” agent may also be provided with an Ultra Short Baseline (USBL) transceiver or other like communication device for providing positioning data to other AUVs in the pod (e.g., “Beta” agents) that may not have the same hardware and/or capabilities as the one or more “Alpha” agents. This hierarchical arrangement allows for long-range execution of operational behaviors that employ large numbers of AUVs at a lower cost. The use of a primary Alpha AUV with enhanced navigation capabilities and components to distribute position data among lower-cost Beta AUVs distributes cost across the pod to lower the aggregate price of the swarm. This arrangement allows for high-volume coordinated operations coupled with long-range clandestine infiltrations. For example, an Alpha agent may lead a formation of Beta agents to rapidly scan large areas of the seabed for mines, sensors, and/or other objects ahead of a manned asset (e.g., such as a manned submarine), conduct coordinated attacks synchronized in time and space with armed units, and/or other like coordinated operations.

In non-limiting embodiments, a surface vessel, such as a boat, may include a USBL or other like communication device to provide navigational data to an AUV during a long-range underwater movement. The boat mounted USBL may provide geolocation data (e.g., GNSS and/or the like) to an AUV agent (e.g., such a subsurface agent that is in or comes within communication range) via the acoustic modem of the USBL or other communication device. Subsurface wireless geolocation provides useful information for the inertial navigation system of the AUV. The accuracy of a MEMs-based or lower level of performance inertial navigation system typically degrades outside of acceptable parameters for precision operations within 2 nm or the like. In non-limiting embodiments, an acceptable navigational accuracy may be obtained within 10 nm, as an example. In non-limiting embodiments, a pod of agents led by an Alpha agent may, for example, cover a navigational route several times the width of a single sonar in a single pass.

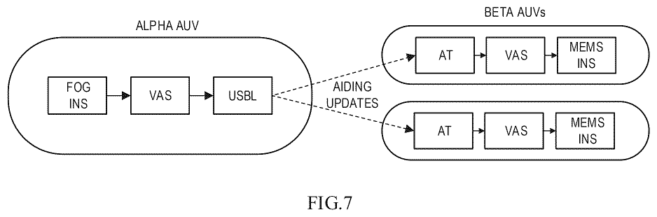

As shown in FIG. 7, an Alpha agent includes a FOG-based inertial navigation system, an autonomy system (e.g., software executed by one or more onboard computing devices), and a USBL communication device. It will be appreciated that other and/or different components may be used in an Alpha agent in non-limiting embodiments such that the Alpha agent provides for precision navigational accuracy while GPS denied during long range missions. The Beta agents may use a cheaper MEMS-based inertial navigation system for navigation which can perform acceptably for short distances while GPS denied but become unreliable after several miles of dead reckoning. The Beta AUV may also be equipped with a single standard acoustic transducer (AT) which provides communication but no in-situ localization of the other vessels. It will be appreciated that the pictured and described components of the Alpha and Beta agents are for example purposes only and that various other components may be used. For example, Beta agents may include any fewer and/or lower-cost components than an Alpha agent.

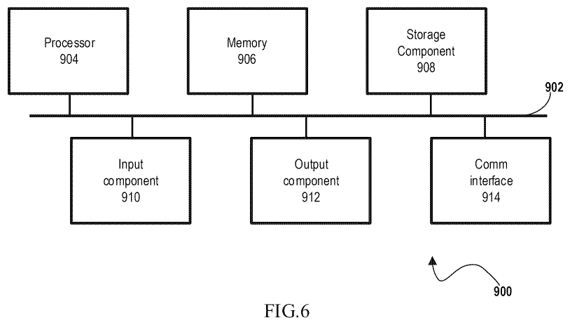

Referring now to FIG. 6, shown is a diagram of example components of a computing device 900 for implementing and performing the systems and methods described herein according to non-limiting embodiments. In some non-limiting embodiments, device 900 may include additional components, fewer components, different components, or differently arranged components than those shown in FIG. 6. Device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 6, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a photo-sensor, a camera, a thermal sensor, an electromagnetic field sensor, a global positioning system (GPS) component, a laser projector, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is

1. A method comprising:
determining, with at least one autonomous underwater vehicle (AUV) of a plurality of AUVs arranged in a swarm, 3D data of at least a portion of an environment of the at least one AUV;
determining, with the at least one AUV based on the 3D data, at least one object and a position of the at least one object in the environment;
receiving, with the at least one AUV from at least one other AUV of the plurality of AUVs, data representing the at least one object and the position of the at least one object;
generating, with the at least one AUV while traveling in the swarm, updated 3D data based on the 3D data and the data representing the at least one object and the position of the at least one object from the at least one other AUV; and
regenerating, with the at least one AUV while traveling in the swarm, the updated 3D data based on new 3D data determined by the at least one AUV and new data representing the at least one object and the position of the at least one object from the at least one other AUV or a different AUV.

2. The method of claim 1, wherein the at least one AUV is configured to communicate with at least one other vehicle via at least one communication modes.

3. The method of claim 2, wherein the at least one communication modes comprise a first mode and a second mode, wherein the first mode comprises at least one of acoustic communication, magnetic communication, and visual communication, and wherein the second mode comprises radio frequency communication.

4. The method of claim 1, further comprising:
controlling the at least one AUV to travel to a surface;
determining, while on or within a threshold distance of the surface, a location based on a global positioning system signal;
controlling the at least one AUV to travel to the swarm in a submerged location below the surface; and
communicating data based on the location determined while on or within a threshold distance of the surface to one or more other AUVs of the plurality of AUVs.

5. The method of claim 1, further comprising:
receiving, with the at least one AUV, location data from at least one surface vessel, wherein the position of the at least one object in the environment and/or a position of the at least one AUV is determined based on the location data received from the at least one surface vessel.

6. The method of claim 5, wherein the location data is represented by acoustic waves received by the at least one AUV with at least one hydrophone array, and wherein the acoustic waves are received as phase-shifted time-series data, and wherein the location data is determined based on beamforming the phase-shifted time-series data received by each hydrophone in the at least hydrophone one array.

7. The method of claim 1, further comprising:
assigning a classification from at least two classifications to each AUV of the plurality of AUVs, the at least two classifications comprising a mapping class and an interceptor class, wherein the at least one AUV is classified in the mapping class.

8. The method of claim 7, wherein AUVs classified in the mapping class are configured to generate updated 3D data, and wherein AUVs classified in the interceptor class are not configured to generate updated 3D data.

9. The method of claim 7, further comprising:
controlling at least one second AUV of the plurality of AUVs to track and/or target at least one entity, the at least one second AUV classified in the interceptor class.

10. The method of claim 7, further comprising:
automatically assigning the classification based on an optimization algorithm and at least one AUV parameter of each AUV.

11. The method of claim 1, wherein determining the 3D data is based on a simultaneous localization and mapping algorithm that receives, as input, depth sensor data and inertial data from the at least one AUV.

12. The method of claim 1, wherein the data representing the at least one object and a spatial position of the at least one object is received from the at least one other AUV via at least one of an acoustic communication interface and a magnetic communication interface.

13. The method of claim 1, wherein generating the updated 3D data comprises:
matching the at least one object with the data representing the at least one object and the position of the at least one object received from the at least one other AUV; and
in response to determining that the at least one object matches the data representing the at least one object and the position of the at least one object received from the at least one other AUV, modifying the 3D data to generate the updated 3D data, the method further comprising:
communicating, from the at least one AUV to the at least one other AUV, a confirmation message comprising an identification of the at least one object used to generate the updated 3D data.

14. The method of claim 1, further comprising:
storing, with the at least one AUV, the 3D data in association with the at least one object and the position of the at least one object in a database local to the at least one AUV.

15. The method of claim 1, further comprising:
determining, with at least one sensor, a sound velocity profile for water in which the plurality of AUVs are submerged;
determining a propagation model based on the sound velocity profile; and
communicating the data representing the at least one object and the position of the at least one object from the at least one other AUV based on the propagation model.

16. The method of claim 1, wherein regenerating the updated 3D data comprises:
performing a sweep algorithm on the updated 3D data to generate a local database of objects; and
classifying the at least one object based on a predetermined semantic database and the local database of objects.

17. A system comprising:
at least one processor of at least one autonomous underwater vehicle (AUV) of a plurality of AUVs arranged in a swarm, the at least one processor configured to:
determine 3D data of at least a portion of an environment of the at least one AUV;
determine, based on the 3D data, at least one object and a position of the at least one object in the environment;
receive, from at least one other AUV of the plurality of AUVs, data representing the at least one object and the position of the at least one object;
generate, while traveling in the swarm, updated 3D data based on the 3D data and the data representing the at least one object and the position of the at least one object from the at least one other AUV; and
regenerate the updated 3D data based on new 3D data determined by the at least one AUV and new data representing the at least one object and the position of the at least one object from the at least one other AUV or a different AUV.

18. The system of claim 17, wherein the at least one AUV is configured to communicate with at least one other vehicle via at least one communication mode.

19. The system of claim 18, wherein the at least one communication modes comprise a first mode and a second mode, wherein the first mode comprises at least one of acoustic communication, magnetic communication and visual communication, and wherein the second mode comprises radio frequency communication.

20. The system of claim 17, wherein regenerating the updated 3D data comprises:
performing a sweep algorithm on the updated 3D data to generate a local database of objects; and
classifying the at least one object based on a predetermined semantic database and the local database of objects.

21. A computer program product comprising at least one non-transitory computer-readable medium including program instructions that, when executed by at least one processor, cause the at least one processor to perform operations comprising:
determining, with at least one autonomous underwater vehicle (AUV) of a plurality of AUVs arranged in a swarm, 3D data of at least a portion of an environment of the at least one AUV;
determining, with the at least one AUV based on the 3D data, at least one object and a position of the at least one object in the environment;
receiving, with the at least one AUV from at least one other AUV of the plurality of AUVs, data representing the at least one object and the position of the at least one object;
generating, with the at least one AUV while traveling in the swarm, updated 3D data based on the 3D data and the data representing the at least one object and the position of the at least one object from the at least one other AUV; and
regenerating, with the at least one AUV while traveling in the swarm, the updated 3D data based on new 3D data determined by the at least one AUV and new data representing the at least one object and the position of the at least one object from the at least one other AUV or a different AUV.

22. A method comprising:
classifying at least one autonomous underwater vehicle (AUV) of a plurality of AUVs as a primary AUV, the primary AUV comprising a transceiver and a high level of performance inertial navigation system;
classifying remaining AUVs of the plurality of AUVs as secondary AUVs, each secondary AUV comprising a low level of performance inertial navigation system; and
controlling the plurality of AUVs by configuring the primary AUV for an objective, the primary AUV configured to control the remaining AUVs using the transceiver based on the objective and a position of the primary AUV.

23. A system comprising:
at least one first autonomous underwater vehicle (AUV) comprising a processor, a transceiver, and a high level of performance inertial navigation system; and
a plurality of second AUVs comprising at least a processor, a receiver, and a low level of performance inertial navigation system, wherein the at least one first AUV is configured to control the plurality of second AUVs.
